(19) United States
(12) Patent Application Publication
(10) Pub. No.: US 2010/0328089 A1
(43) Pub. Date: Dec. 30, 2010

(54) Dead bolt lock reminder using passive receiver

(76) Inventors: Joseph Eichenstein, Lakewood, NJ (US); John V. Mizzi, Poughkeepsie, NY (US)

Correspondence Address: ALFRED M. WALKER, 225 OLD COUNTRY ROAD, MELVILLE, NY, 11747-2712, US

(21) Appl. No.: 12/584,478

(22) Filed: Sep. 4, 2009

Related U.S. Application Data
(63) Continuation-in-part of application No. 12/456,218, filed on Jun. 13, 2009.
(60) Provisional application No. 61/274,731, filed on Aug. 19, 2009.
(60) Provisional application No. 61/274,288, filed on Aug. 14, 2009.

(51) Int. Cl. G08B 21/00

(52) U.S. Cl. 340/686.4; 340/10.4

(57) ABSTRACT

A dead bolt lock reminder system includes a dead bolt lock mechanism including a dead bolt for mounting in a door to be secured in a closed door state and a transmitter subsystem constructed for positioning proximate the deadbolt lock mechanism and which further includes a transmitter and a detector. The detector is configured for detecting when the dead bolt is moved from a locked state position to an unlocked state position and from an unlocked state position to a locked state position and where the transmitter is configured for transmitting a dead lock reminder signal identifying that a state of the dead bolt has changed to one of locked and unlocked upon detection of same by the detector. A hand held receiver subsystem is configured to receive the dead lock reminder signal at a time of transmission, and maintain a status of a last change to a locked or an unlocked state for displaying to a user of the hand held receiver subsystem.

### CROSS REFERENCE TO RELATED APPLICATION

The invention described and claimed hereinbelow is continuation-in-part of U.S. patent application Ser. No. 12/456,218, filed on Jun. 13, 2009, and which is further described in substance within U.S. Provisional Patent Applicant No. 61/274,731, filed Aug. 19, 2009 and 61/274,288 filed Aug. 14, 2009, which provide the basis for a claim of priority of invention under 35 U.S.C. 119(a)-(d). These applications are incorporated by reference herein.

### FIELD OF THE INVENTION

The present invention relates to a dead bolt lock reminder preferably using a passive receiver, which receives a signal enabling a user to ascertain at a later time whether a dead bolt lock was not locked in the recent temporal past.

### BACKGROUND OF THE INVENTION

Residents often leave their home, e.g., house, apartment, garage, store, etc., and at some point in time thereafter wonder whether they locked the dead bolt of their front door. Where they think of it while on the premises, e.g., in the car on the driveway, they have to get out of the car and return to the house or apartment to check or verify that the door is bolted. When the thought occurs to them that they may not have locked the dead bolt at some distance to their home or apartment, and they cannot readily return home to verify, their concern and anxiety level will typically increase.

Some such residents may be lucky enough to have a neighbor, friend or relative they can call to travel to the house or apartment and determine whether the dead bolt is locked in place, but most residents are not so fortunate. For that matter, a person without a key to the dead bolt may be unable to accurately determine its locked/unlocked status.

In order to address the problem, and provide residents that tend to forget whether they have actually locked their dead bolt, various remote status checking devices have developed. That is, various remote status checking devices are known to use radio communications links.

For example, U.S. Pat. No. 7,498,936 to Maeng describes a wireless event status system that can be used to ascertain the status of a building door lock remotely. In Maeng, an informer transmitter at the door operates to transmit a status signal whenever the door lock status is changed. A receiver in a remote key fob receives the signal since it is always in the active receive state. A visual indicator in the form of a status light on the key fob is turned on or off in response to the received signal, i.e., to indicate whether the door is locked or unlocked. This last status is stored in the key fob for interrogation when the key fob is out of range of the informer transmitter.

Maeng's FIG. 4 illustrates a functional block diagram of a wireless enabled notification system employing a remote status notification device having a processor with memory operable to store a current state according to one aspect of the invention. Informer 420 includes a processor 402, and a radio transmitter 403 operable to send and receive wireless signals such as RF signals using antenna 404 and wireless communication medium 410. Notification system 400 includes a remote status notification device 411 having a radio receiver 406 coupled to antenna 405 and operable to receive signals via communication medium 410. Remote status notification device 411 further includes a processor with memory 407, an input device 409 such as an acknowledge button, an output device 408 such as an indicator and/or speaker.

Processor 402 formats a status message including an identification that identifies informer 420 and a current status provided by status sensor 401. Upon status sensor 401 providing a status to processor 402 and processor formatting a status message, radio transceiver 403 transmits the encoded status message using wireless communication medium 410 such as an RF communication medium. Radio receiver 406 receives the signal and status message communicated by informer 420 and provides a decoded signal and status message to processor 407. Processor 407 checks the decoded signal to determine if the decoded signal includes a unique identification number for informer 420 and confirms the format of the data using a predefined data format.

Such operation is not only quite complicated, but requires substantial battery power to operate at both ends. For example, Informer 420 requires processor 402 to determine what type signal to send via radio transmitter 403. Moreover, remote status notification device 411 must operate with a processor with memory 407 to process the received signals and communicate the proper notification commends to input device. That is, processor 407 must check the decoded signal to determine if the decoded signal includes a unique identification number for informer 420 and confirms the format of the data using a predefined data format.

### OBJECTS OF THE INVENTION

It is therefore an object of the present invention to preferably provide a dead bolt lock reminder system comprising a passive receiver that stores a reminder signal or starts an incremental timer, which when accessed, enables a resident who may not recall whether they locked the dead bolt to ascertain at a later time whether the dead bolt was left unlocked in the recent temporal past.

The novel dead bolt lock reminder is intended to be used with any conventional dead bolt, or dead bolt system utilized to secure any type door, for example, inner doors, outer doors, garage doors, cabin doors, etc., with out limitation, used to restrict access in any home, house, apartment, garage, store, business, boat, warehouse, etc., without limitation,

Other objects will become apparent from the following description of the present invention.

### SUMMARY OF THE INVENTION

The purpose of this invention is to provide a dead bolt lock reminder system whereby a concerned person at a remote location is enabled to inquire as to the time and date of the last time a dead bolt lock in place at a door in the person's home or business was locked. This inventive dead bolt lock reminder system is able to help the concerned person remember to lock the dead bolt. If the inquiry is made close enough to the door to be locked with the dead bolt lock, and if the dead bolt lock reminder system has determined that the dead bolt lock is in an unlocked state, the concerned person can return to the store or home and lock the dead bolt.

The dead bolt lock reminder system is implemented in two cooperating subsystems. The first subsystem comprises a hand held receiver subsystem, such as, for example, a receiver subsystem constructed into a hand held housing, such as a key fob or like communication signal receiving device. Where the receiver subsystem comprises a key fob, the key fob is typically attached to the lock key as per a key chain. The hand held receiver subsystem is preferably a passive receiver which is receptive to a received signal, such as an RF signal. The RF reminder signal enables the passive receiver to receive date and time information for storage in non-volatile memory from a transmitter in close proximity (the other subsystem) which is energized when the dead bolt enters the recess in the door jamb thereby locking the door. The locking action is sensed by a normally open sensor switch which physically engages the dead bolt. The information thus stored on the key fob may be displayed on the surface of the key fob by pressing a momentary switch button thereby powering a display via a small button battery or cell within.

In more details, the received information comprising the received reminder signal may be displayed in a display device associated with the surface of the hand held receiver. In one embodiment, the data may be displayed automatically upon receipt, avoiding any need for a memory in the receiver subsystem. Alternatively, the data is stored in memory and retrieved for display by a manual data input, such as by pressing a momentary switch button by the system user. The display is powered by a power source, such as a small button battery or cell within. The technology to implement this system has been proven through the wide use of passive identification devices, such as, for example, RFID tags and RFID readers in the consumer product industry.

Therefore, the action of locking the dead bolt causes a short powerful transmission of the current day and time for storage on the key fob whereby this information is portable and accessible at any time or place. The key fob will display the last time and day of locking the dead bolt. The reader should note that while the receiver subsystem is described as communicating the last locked/unlock status using a visual display device; the invention is not limited thereto. That is, the receiver subsystem may comprise any known device or means for communicating a locked or unlocked condition. For example, the status may be communicated to a system user in possession of the hand held receiver subsystem using apparatus providing a visual, tactile or auditory signal. But in the case of a display device, the hand held receiver subsystem displays the last time and day of locking the dead bolt. For example, and in a case where the last time the dead bolt lock was locked is not “today”, the dead bolt can be presumed to be unlocked (unless someone else locked it). The previous time and day is automatically overlaid by the current data with every transmitter subsystem operation.

The second subsystem of the dead bolt lock reminder system comprises a transmitter subsystem located at the door proximate the dead bolt lock. The transmitter subsystem is energized to generate and send the reminder signal when it detects that the dead bolt enters the recess associated with the door lock, thereby locking the door. For example, the dead bolt may be installed and positioned in a door jamb of a residential or business door. That is, the locking action is detected by a sensor comprising the transmitter subsystem, such as a normally open sensor switch that physically engages the dead bolt. The sensor responds by activating the transmitter comprising the transmitter subsystem to transmit a short powerful transmission modulated with data comprising the current day and time.

In an alternate embodiment, the transmitter subsystem is simplified so that it just emits a simple data output, such as a single RF burst upon detecting that the dead bolt is locked, and then shuts down. This single RF burst is received by and used by the hand held receiver subsystem, such as a key fob, which includes the passive receiver. The passive receiver is “awakened” by receipt of this single RF burst and resets a free-running elapsed time counter with integral display which is also housed in the hand held receiver, such as a key fob. In this way, locking of the dead bolt lock resets the display which starts displaying elapsed time (hours and minutes) from that point on. The display and counter are always on and these can be a standard stop watch module with integral display. In an alternate embodiment, the time counter provides an elapsed time (such as, for example, in hours and/or minutes) from that point on, which is displayed or otherwise communicated to the concerned user. In this embodiment, the display and counter are always on. In one embodiment, the free-running elapsed time counter comprises a standard stop watch module with integral display.

The receiver subsystem is constructed so that it does not include a real-time clock or time/date storage means in this embodiment. So in the case where the display of the elapsed time counter overflows, visually displayed digits go blank but the dots demarking hours and minutes will keep operating repetitively. For example, the hand held receiver subsystem can emit a vibratory signal, an auditory signal or a visual signal, for example, by blinking at a predetermined rate, such as, for example, one per second rate. The user can easily determine if he or she had forgotten to lock the dead bolt by viewing, feeling or hearing the display. If the elapsed time shown (or overflow condition) is greater than the time since he or she had left the door site, the status of the dead bolt is “NOT LOCKED” (unless someone else locked it after departure). The user need not be aware of the date.

The transmitter is configured for transmitting a dead lock reminder signal identifying that a state of the dead bolt has changed to one of locked or unlocked upon detection of same by the detector. The hand held receiver subsystem is configured in a hand held housing to receive the dead lock reminder signal at a time of transmission, and maintain a status of a last change to a locked or an unlocked state for communication to a user of the hand held receiver subsystem. The detector of the transmitter subsystem comprises a sensor switch which is arranged to engage the dead bolt to generate and direct a detection signal to the transmitter that activates transmission of the dead lock reminder signal at a change of state of the dead bolt. Preferably, the transmitter subsystem sensor includes a real time clock that supplies a time and date for embedding into the dead lock reminder signal, and wherein the transmitter modulates the dead lock reminder signal to include the time and date. The transmitter within the transmitter subsystem generates a single, short RF burst comprising the dead lock reminder signal modulated to include at least the change of state of the dead bolt, and then shuts down. In an alternate embodiment, the transmitter in the transmitter subsystem can be a transmitter as known to those skilled in the art, such as for example, a Bluetooth transmitter, a Wi-Fi transmitter that transmits according to IEEE 802.11 or a transmitter subsystem comprising a power control module.

### BRIEF DESCRIPTION OF THE DRAWINGS

The present invention can best be understood in connection with the accompanying drawings. It is noted that the invention is not limited to the precise embodiments shown in drawings, in which:

FIG. 1 is a perspective view of the exterior of a door with a dead bolt and the transmitter of this reminder system;

FIG. 2 is an end view detail of the door showing the relative location of the transmitter and the key fob of this invention;

FIG. 3 is a high level block diagram of both the transmitter and the key fob subsystems comprising this invention;

FIG. 4 is a front elevation of a door and wall detail of an alternate embodiment of this invention using an elapsed time counter; and;

FIG. 5 is a high level block diagram of both the transmitter and the key fob subsystems of the alternate embodiment shown in FIG. 4.

### DETAILED DESCRIPTION OF THE INVENTION

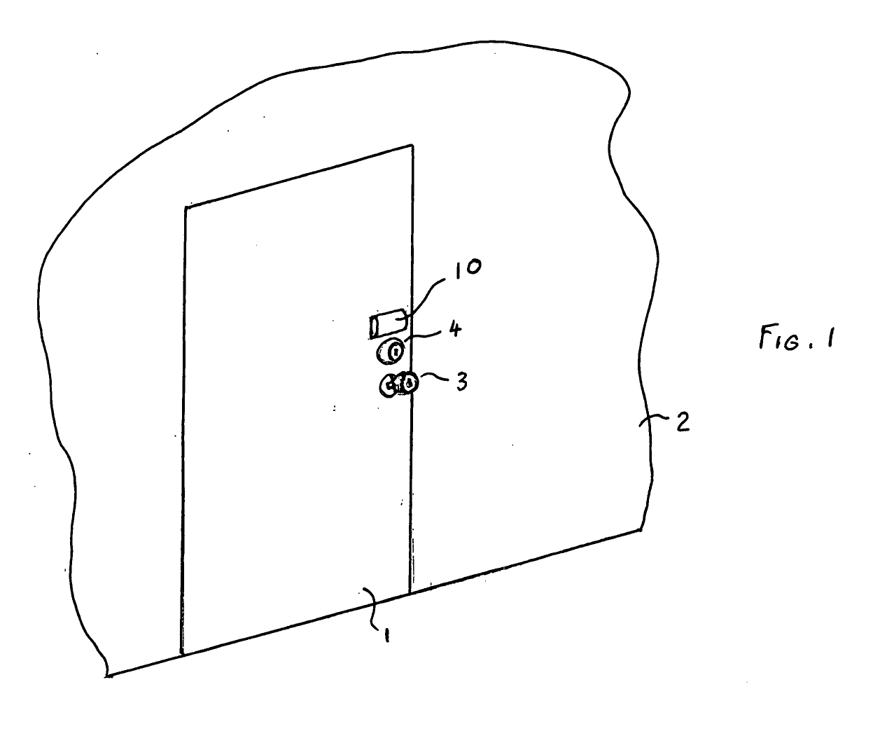

FIG. 1 shows the exterior of door 1 in wall 2 of any house, store, warehouse, apartment, etc. Door knob 3 and dead bolt lock 4 are shown below a transmitter subsystem 10 of this invention.

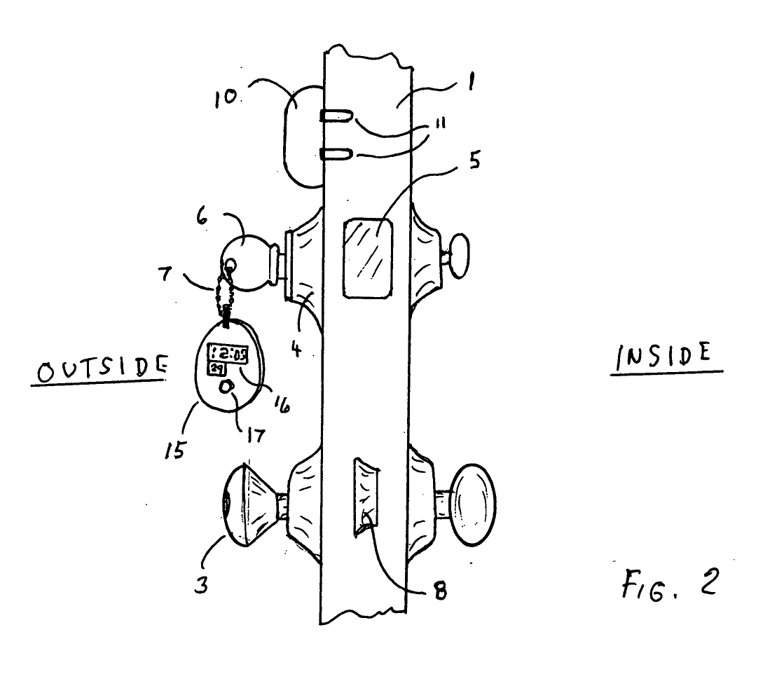

FIG. 2 shows an end view detail of door 2 showing the close proximity of a hand held receiver subsystem 15 to dead bolt lock 4 and dead bolt 5. In the embodiment shown, hand held receiver subsystem 15 comprises a key fob. Transmitter subsystem 10 transmits a reminder signal to the hand held receiver subsystem 15 when key 6 is in dead bolt lock 4. Preferably, a connector includes a pair of contacts, such as, for example, spring contacts 11. The spring contacts overlap the edge of door 1 and are connected to transmitter subsystem 10. The contacts 11 are used to connect a sensor, such as a sensor switch in a door jamb recess when door 1 is closed.

Alternatively, transmitter subsystem 10 can be located elsewhere in the vicinity of the dead bolt lock 4 and dead bolt 5, such as to the wall across from dead bolt lock 4 to eliminate the need for contacts 11. Since the hand held receiver subsystem, such as key fob 15, is preferably attached via key chain 7, or other receiver housing, this important close proximity is easily maintained.

Also shown in FIG. 2 is snap lock tang 8 and dead bolt 5 in a retracted position. Shown on the hand held receiver subsystem 15, such as key fob, are time and date display 16, and a user input device 17, such as, for example, momentary switch button (which preferably must be pressed to display time and date).

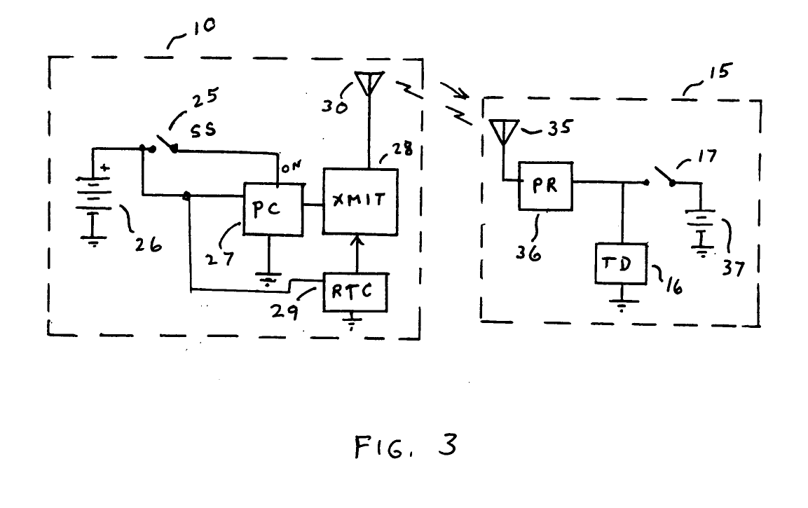

FIG. 3 is a block diagram of the various electrical components comprising the circuitry for both subsystems. The hand held receiver subsystem 15, such as, for example, the key fob as shown comprises an antenna 35 connected to a passive receiver 36, and a time display 16. Each device is powered by power supply 37, preferably a DC cell. Alternatively, the hand-held receiver subsystem can be powered as are known RFID devices, i.e., powered and activated by received RFID signals.

The time and date signal may be displayed, and/or stored in a memory found in the passive time display 16, or in non-volatile storage in passive receiver 36. Old messages are simply overwritten to avoid clutter of old messages. That is, preferably, older data is simply overlaid by new data. When the input device 17, such as the momentary push button shown, is energized, the stored time/date data is displayed in the time display 16. The preferred display technology is LCD although other visual, auditory or tactile (vibrating) technologies such as LED may be used alone or in combination.

Transmitter subsystem 10 uses a power source 26, such as, for example, the internal battery as shown (e.g., 2-4 AA alkaline cells). Power control module 27 powers transmitter block 28 for a period sufficient for data transmission and then shuts off power. Transmission is initiated by the closing of a sensor 25, such as the dead bolt sensor switch as shown. Real-time clock module 29 is “always on” and supplies the time and date to be transmitted. The reminder signal generated for transmission by the transmitter 28 is sent via antenna 30, as mentioned, for receipt with antenna 35 in the hand held receiver subsystem 15.

In an alternate embodiment, both transmitter block 28 as well as passive receiver 36 are replaced by transceivers so that an acknowledgment signal can be sent back to therebetween to verifying good reception of time/date data within the reminder signal. A retransmission can commence at the transmitter subsystem 10 if no acknowledgment is received thereat shortly after transmission. The RF signal still powers block 36 even if replaced by a transceiver (as in typical RFID applications).

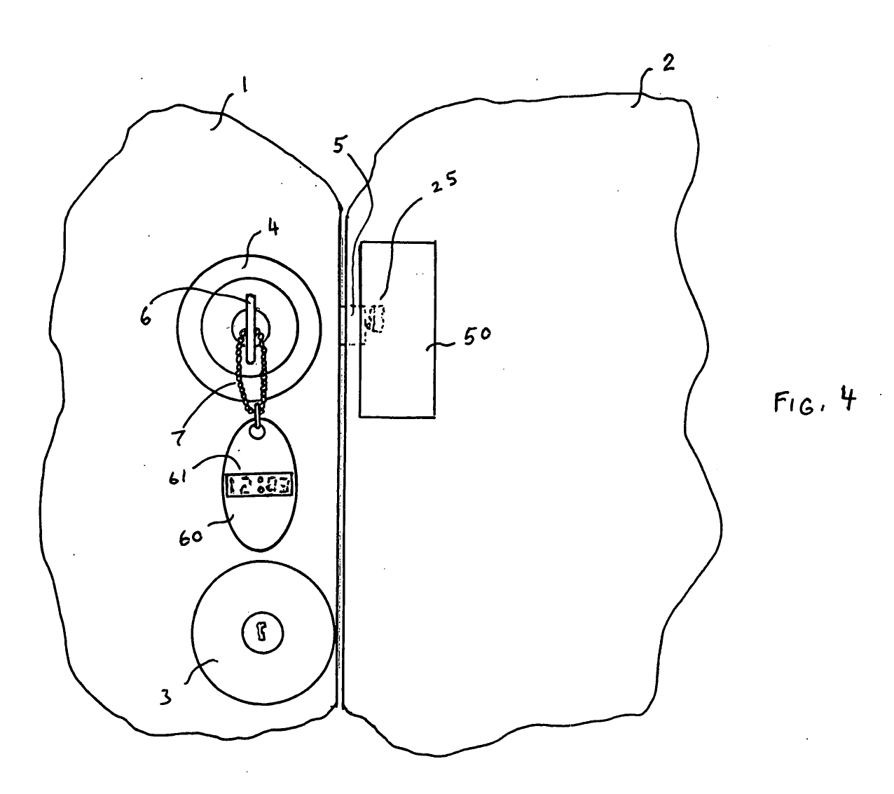

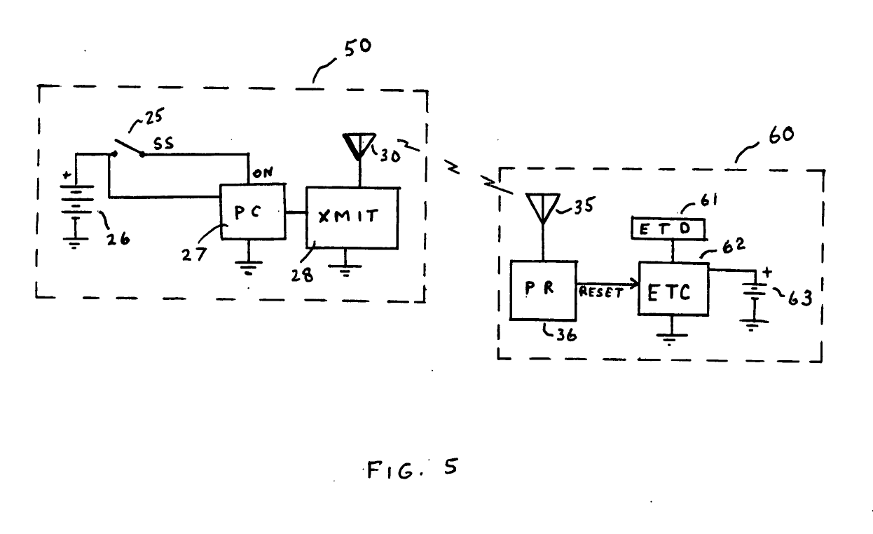

In another alternate embodiment, shown in FIGS. 4 and 5, a different method is used to convey locked/unlocked information to the user. In the detail of FIG. 4, transmitter subsystem 50 is mounted in the vicinity of the dead bolt lock 4, such as, for example, on the stationary wall 2 as shown. Dead bolt 5 and sensor switch 25 are shown in phantom view within the recess in the door jamb (in a locked position), optionally located underneath transmitter subsystem 50. In this manner, no pairs of contacts 11, as required in the embodiment shown in FIGS. 1 and 2, are needed to connect transmitter subsystem 50 to switch 25 (i.e., contacts both reside on the same side of the door/jamb interface). Note that the hand held receiver subsystem 60, such as the key fob as shown, no pushbutton is included (or required) as the display 61 continuously indicates elapsed time since the last lock operation.

In FIG. 5, transmitter 28 is just used to emit the reminder signal, such as a single RF burst, when the power control module 27 senses switch 25 closing (upon impingement by deadbolt 5). Transmitter 28 is then shut down. Passive receiver 36 in the hand held receiver subsystem 60, such as, for example, the key fob as shown, is powered by the energy comprising the RF burst, and responds by sending a reset pulse to elapsed time counter 62. Please note that elapsed time counter 62 is continuously powered by a power source 63, such as the button cells as shown. Elapsed time display 61 displays the count, such as, for example, as hours and minutes.

A standard stop watch module with integral display can be used, but its physical length and “not useful” seconds display may dictate against it. If a normal wrist watch time display is used with a limitation of “blank” or “1” for the high order digit, the maximum elapsed time that can be displayed would be 19 hours and 59 minutes. This should be sufficient for the present application. After that, the overflow condition would be displayed as demarcation dots flashing once per second. It should be intuitive for a user to interpret elapsed time since departing from a locked door, relative to that since the last time the door site was actually visited; if they are approximately the same, the door had been properly locked.

In the foregoing description, certain terms and visual depictions are used to illustrate the preferred embodiment. However, no unnecessary limitations are to be construed by the terms used or illustrations depicted, beyond what is shown in the prior art, since the terms and illustrations are exemplary only, and are not meant to limit the scope of the present invention.

It is further known that other modifications may be made to the present invention, without departing the scope of the invention, as noted in the appended Claims.

I claim:

1. A dead bolt lock reminder system, comprising:
a dead bolt lock mechanism including a dead bolt for mounting in a door to be secured in a closed door state;
a transmitter subsystem constructed for positioning proximate the deadbolt lock mechanism and comprising a transmitter and a detector, where the detector is configured for detecting when the dead bolt is moved from a locked state position to an unlocked state position and from an unlocked state position to a locked state position and where the transmitter is configured for transmitting a dead lock reminder signal identifying that a state of the dead bolt has changed to one of locked and unlocked upon detection of same by the detector; and
a hand held receiver subsystem configured to receive the dead lock reminder signal at a time of transmission, and maintain a status of a last change to a locked or an unlocked state for communication to a user of the hand held receiver subsystem.

2. The dead lock reminder system as set forth in claim 1, wherein said detector of said transmitter subsystem comprises a sensor switch is arranged to engage the dead bolt to generate and direct a detection signal to the transmitter that activates transmission of the dead lock reminder signal at a change of state of the dead bolt.

3. The dead lock reminder system as set forth in claim 1, wherein the transmitter subsystem sensor includes a real time clock that supplies a time and date for embedding into the dead lock reminder signal, and wherein the transmitter modulates the dead lock reminder signal to include the time and date.

4. The dead lock reminder system as set forth in claim 1, wherein the transmitter within the transmitter subsystem generates a single, short RF burst comprising the dead lock reminder signal modulated to include at least the change of state of the dead bolt, and then shuts down.

5. The dead lock reminder system as set forth in claim 1, wherein the transmitter in the transmitter subsystem is a Bluetooth transmitter.

6. The dead lock reminder system as set forth in claim 1, wherein the transmitter in the transmitter subsystem is a Wi-Fi transmitter that transmits according to IEEE 802.11.

7. The dead lock reminder system as set forth in claim 1, wherein the transmitter subsystem comprises a power control module.

8. The dead lock reminder system as set forth in claim 1, wherein the transmitter subsystem is arranged to be positioned in the door, and further includes a connector comprising spring contacts for connecting at least the detector to the dead lock or dead lock mechanism.

9. The dead lock reminder system as set forth in claim 1, wherein the hand-held receiver subsystem is housed in a key fob.

10. The dead lock reminder system as set forth in claim 1, wherein the receiver subsystem comprises a passive receiver that is activated upon receipt of the dead lock reminder signal.

11. The dead lock reminder system as set forth in claim 1, wherein the receiver subsystem comprises a push switch that upon pushing by a user, communicates the last known state to which the dead lock was changed.

12. The dead lock reminder system as set forth in claim 1, wherein the receiver subsystem comprises a display device that visually displays the last known state to which the dead lock was changed.

13. The dead lock reminder system as set forth in claim 12, wherein the receiver subsystem comprises a push switch and a real time clock that identifies a time and date at which the dead lock reminder signal is received, and communicates same for display by the display device upon activation of the push switch.

14. The dead lock reminder system as set forth in claim 12, wherein the receiver subsystem comprises a free-running elapsed time counter that identifies the lapsed time since receipt of the last received dead lock reminder signal on the display device automatically upon receipt, and wherein the elapsed time of the receipt of the dead bolt reminder signal is continuously updated by the elapsed timer counter over time.

15. The dead lock reminder system as set forth in claim 1, wherein the receiver subsystem comprises a memory within which data extracted from the dead lock reminder signal is stored.

16. The dead lock reminder system as set forth in claim 11, wherein the receiver subsystem comprises one of an vibratory device, auditory device and light stimulating device that communicates that the last known state of the dead lock has changed, upon activation of the epoch switch by the user.

17. A dead bolt lock reminder system, comprising:
a dead bolt lock mechanism including a dead bolt for mounting in a door to be secured in a closed door state;
a transmitter subsystem constructed for positioning proximate the deadbolt lock mechanism and comprising a transmitter and a detector, where the detector is configured for detecting when the dead bolt position is changed from a locked position to an unlocked position, and from an unlocked position to a locked position and where the transmitter is configured for transmitting a dead lock reminder signal including data identifying whether the dead bolt is in a locked or unlocked position, and a time of detection at detection of the change by the detector; and
a hand held receiver subsystem including communication device and a passive receiver configured to receive the dead lock reminder signal at a time of transmission, wherein the hand held receiver subsystem extracts data from the dead lock reminder signal as to the locked or unlocked state of the dead lock and the time at which the change of state was detected, and wherein the communication device communicates same to the user of the hand held receiver subsystem.

18. The dead lock reminder system as set forth in claim 17, wherein said detector of said transmitter subsystem comprises a sensor switch is arranged to detect the change of dead bolt state and direct the transmitter that activate transmission of the dead lock reminder signal in response thereto.

19. The dead lock reminder system as set forth in claim 17, wherein the transmitter subsystem is arranged to be positioned in the door, and further includes a connector comprising spring contacts for connecting at least the detector to the dead lock or dead lock mechanism.

20. The dead lock reminder system as set forth in claim 17, wherein the hand-held receiver subsystem is housed in a key fob.

21. The dead lock reminder system as set forth in claim 17, wherein the receiver subsystem comprises a push switch that upon pushing by a user, communicates the last known state to which the dead lock was changed.

22. The dead lock reminder system as set forth in claim 17, wherein the receiver subsystem comprises a display device that visually displays the last known state to which the dead lock was changed.

22. The dead lock reminder system as set forth in claim 22, wherein the receiver subsystem comprises a free-running elapsed time counter that identifies the lapsed time since receipt of the last received dead lock reminder signal on the display device automatically upon receipt, and wherein the elapsed time of the receipt of the dead bolt reminder signal is continuously updated by the elapsed timer counter over time.

23. The dead lock reminder system as set forth in claim 17, wherein the receiver subsystem comprises a memory within which data extracted from the dead lock reminder signal is stored.

24. A dead bolt lock reminder using an RFID based passive receiver, whereby a person in a remote location can inquire as to the time and date of the last time a dead bolt lock having a dead bolt movable into a recess of a door jamb was locked by a locking action caused by movement of a lock key in the lock, as a reminder to help a person remember to lock a dead bolt comprising:
a hand held housing being attached to the lock key, said hand held housing having a passive receiver powered by a received RF signal;
said received RF signal enabling said passive receiver to receive date and time information for storage in non-volatile memory from a transmitter in close proximity to said hand held housing and the lock key, which said transmitter is energized when the dead bolt of the dead bolt lock enters the recess in the door jamb thereby locking the door;
said movable dead bolt engageable with a normally open sensor switch, wherein the locking action is sensed by said normally open sensor switch when said dead bolt physically engages said normally open sensor switch;
said date and time information stored with said hand held housing being displayed on a surface of said hand held housing by pressing of a momentary switch button associated with said hand held housing, thereby powering a display via a power source within said hand held housing,
wherein locking the dead bolt causes a short powerful transmission of the current day and time for storage on hand held housing whereby said date and time information is portable and accessible at any time or place;
said display of said hand held housing displaying the last time and day of locking of the dead bolt.

25. The dead bolt lock reminder using an RFID based passive receiver as in claim 24 wherein a previously displayed time and day is automatically overlaid by current time and date information with each subsequent transmitter operation.

26. The dead bolt lock reminder using an RFID based passive receiver as in claim 24 wherein said hand held housing is a key fob.

27. The dead bolt lock reminder using an RFID based passive receiver as in claim 24 wherein said transmitter and said passive receiver are each a separate transceiver capable of sending back an acknowledgment signal to the transmitter transceiver verifying good reception of said time and date information; wherein further a retransmission commences if said acknowledgment is not received by said transmitter transceiver.

28. A dead bolt lock reminder using an RFID based passive receiver being provided in the absence of real-time clock or time/date storage, whereby a person in a remote location can inquire as to the time and date of the last time a dead bolt lock having a dead bolt movable into a recess of a door jamb was locked by a locking action caused by movement of a lock key in the lock, as a reminder to help a person remember to lock a dead bolt comprising:
a hand held housing being attached to the lock key, said hand held housing having a passive receiver powered by a received RF signal;
said received RF signal enabling said passive receiver to receive date and time information for storage in non-volatile memory from a transmitter in close proximity to said hand held housing and the lock key, which said transmitter is energized when the dead bolt of the dead bolt lock enters the recess in the door jamb thereby locking the door;
said movable dead bolt engageable with a normally open sensor switch, wherein the locking action is sensed by said normally open sensor switch when said dead bolt physically engages said normally open sensor switch;
wherein locking the dead bolt causes said transmitter to emit a single RF burst upon signal that the dead bolt is locked, and then said transmitter shuts down;
said display of said hand held housing displaying the last time and day of locking of the dead bolt;
said passive receiver of said hand held housing being awakened by said transmitted single RF burst, resetting a free-running elapsed time counter with an integral display housed in said hand held housing;
whereby locking of the dead bolt lock resets the display which starts displaying elapsed time from that point on said display and counter being always on.

29. The dead bolt lock reminder using an RFID based passive receiver as in claim 28 wherein when the display of the elapsed time counter overflows, respective digits in said display go blank but respective dots demarking hours and minutes continue to blink at a predetermined rate of time.

30. The dead bolt lock reminder using an RFID based passive receiver as in claim 28 wherein said hand held housing is a key fob.

31. The dead bolt lock reminder using an RFID based passive receiver as in claim 28 wherein a transmitter subsystem including said transmitter is mounted on a stationary wall adjacent to said dead bolt lock.
